(19) United States
(12) Patent Application Publication
(10) Pub. No.: US 2016/0198073 A1
(43) Pub. Date: Jul. 7, 2016

(54) DRIVING CIRCUIT AND PHOTOGRAPHIC MODULE USING THE SAME

(71) Applicant: HIMAX TECHNOLOGIES LIMITED, Tainan (TW)

(72) Inventor: Yan-Fong LAI, Tainan (TW)

(21) Appl. No.: 14/590,463

(22) Filed: Jan. 6, 2015

(51) Int. Cl. H04N 5/225; H04N 5/232

(52) U.S. Cl. CPC H04N 5/2254; H04N 5/23229

(57) ABSTRACT

A driving circuit for controlling a photographic module is included, which includes an input voltage adjusting unit, a digital-to-analog converting unit, a current mirror unit and a sink current generating unit. The input voltage adjusting unit is configured to convert an input voltage signal into an adjusted input voltage signal. The digital-to-analog converting unit is coupled to the input voltage adjusting unit, which is configured to convert the adjusted input voltage signal and a digitalized signal into a fraction of the adjusted input voltage signal. The current mirror unit is coupled to the digital-to-analog converting unit, which is configured to amplify the fraction of the adjusted input voltage signal. The sink current generating unit is coupled to the current mirror unit and the motor, which is configured to generate a sink current based on the fraction of the adjusted input voltage signal.

### BACKGROUND

1. Field of Invention

The invention relates to a driving circuit, and more particularly, to a driving circuit for providing a sink current with high accuracy to adjust a position of a lens and a photographic module using the same.

2. Description of Related Art

Nowadays more and more electronic devices adopt photographic modules to provide the functionalities such as image capturing and video recording. Further, a photographic module may provide an auto-focus function that can automatically determine correct focus and adjust the position of lens without manual control by users. In such photographic module, a motor such as voice coil motor is configured to automatically adjust the position of the lens to the right position based on a current provided by the driving circuit, thereby obtaining a clear image. Thus, the accuracy of the current will affect the image quality of the photographic module.

### SUMMARY

In the invention, a driving circuit is provided for generating a sink current with high accuracy to adjust a position of a lens of a photographic module. The invention also provides a photographic module using the same driving circuit. By using the driving circuit of the invention, the position of the lens of the photographic module can be precisely adjusted, so as to improve the image quality of the photographic module.

An aspect of the invention is to provide a driving circuit for controlling a photographic module. The photographic module has a lens unit and a motor for adjusting a position of the lens unit in the photographic module based on a sink current. The driving circuit includes an input voltage adjusting unit, a digital-to-analog converting unit, a current mirror unit and a sink current generating unit. The input voltage adjusting unit is configured to convert an input voltage signal into an adjusted input voltage signal. The digital-to-analog converting unit is coupled to the input voltage adjusting unit, which is configured to convert the adjusted input voltage signal and a digitalized signal into a fraction of the adjusted input voltage signal. The current mirror unit is coupled to the digital-to-analog converting unit, which is configured to amplify the fraction of the adjusted input voltage signal. The sink current generating unit is coupled to the current mirror unit and the motor, which is configured to generate the sink current.

In one or more embodiments, the current mirror unit includes a first transistor, a second transistor, a third transistor, a fourth transistor and a first operational amplifier. The first transistor has a gate and a drain. The second transistor has a source, a gate and a drain. The source of the second transistor is coupled to the drain of the first transistor, and the gate and the drain of the second transistor is coupled to the gate of the first transistor. The third transistor has a gate and a drain. The gate of the third transistor is coupled to the gate of the first transistor. The fourth transistor has a source, a gate and a drain. The source of the fourth transistor is coupled to the drain of the third transistor. The first operational amplifier has a positive input, a negative input and an output. The positive input of the first operational amplifier is coupled to the drain of the first transistor, the negative input of the first operational amplifier is coupled to the drain of the third transistor, and the output of the first operational amplifier is coupled to the gate of the fourth transistor.

In one or more embodiments, the current mirror unit further includes a second operational amplifier, a fifth transistor, a first resistance unit and a second resistance unit. The second operational amplifier has a positive input, a negative input and an output. The positive input of the second operational amplifier is coupled to the digital-to-analog converting unit. The fifth transistor has a source, a gate and a drain. The source of the fifth transistor is coupled to the negative input of the second operational amplifier, the gate of the fifth transistor is coupled to the output of the second operational amplifier, and the drain of the fifth transistor is coupled to the drain of the second transistor. The first resistance unit is coupled to the source of the fifth transistor. The second resistance unit coupled to the drain of the fourth transistor.

In one or more embodiments, the first resistance unit includes a positive temperature coefficient (PTC) thermistor and a negative temperature coefficient (NTC) thermistor coupled in series.

In one or more embodiments, the input voltage adjusting unit includes a third resistance unit and a fourth resistance unit. The third resistance unit is coupled between an input of the input voltage adjusting unit for receiving the input voltage signal and a point for outputting the adjusted input voltage signal. The fourth resistance unit is coupled between the point and a grounding end.

In one or more embodiments, the third resistance unit includes a laser trimmable resistor or a digitally controlled resistor.

In one or more embodiments, the fourth resistance unit includes a laser trimmable resistor or a digitally controlled resistor.

In one or more embodiments, the driving circuit further includes an input voltage generating unit for providing the input voltage signal.

Another aspect of the invention is to provide a photographic module. The photographic module includes a lens unit, a motor and a driving circuit. The motor is coupled to the lens unit. The motor is configured to adjust a position of the lens unit in the photographic module based on a sink current. The driving circuit is coupled to the motor and includes an input voltage adjusting unit, a digital-to-analog converting unit, a current mirror unit and a sink current generating unit. The input voltage adjusting unit is configured to convert an input voltage signal into an adjusted input voltage signal. The digital-to-analog converting unit is coupled to the input voltage adjusting unit, which is configured to convert the adjusted input voltage signal and a digitalized signal into a fraction of the adjusted input voltage signal. The current mirror unit is coupled to the digital-to-analog converting unit, which is configured for amplifying the fraction of the adjusted input voltage signal. The sink current generating unit is coupled to the current mirror unit and the motor, which is configured to generate the sink current.

In one or more embodiments, the current mirror unit includes a first transistor, a second transistor, a third transistor, a fourth transistor and a first operational amplifier. The first transistor has a gate and a drain. The second transistor has a source, a gate and a drain. The source of the second transistor is coupled to the drain of the first transistor, and the gate and the drain of the second transistor is coupled to the gate of the first transistor. The third transistor has a gate and a drain. The gate of the third transistor is coupled to the gate of the first transistor. The fourth transistor has a source, a gate and a drain. The source of the fourth transistor is coupled to the drain of the third transistor. The first operational amplifier has a positive input, a negative input and an output. The positive input of the first operational amplifier is coupled to the drain of the first transistor, the negative input of the first operational amplifier is coupled to the drain of the third transistor, and the output of the first operational amplifier is coupled to the gate of the fourth transistor.

In one or more embodiments, the current mirror unit further includes a second operational amplifier, a fifth transistor, a first resistance unit and a second resistance unit. The second operational amplifier has a positive input, a negative input and an output. The positive input of the second operational amplifier is coupled to the digital-to-analog converting unit. The fifth transistor has a source, a gate and a drain. The source of the fifth transistor is coupled to the negative input of the second operational amplifier, the gate of the fifth transistor is coupled to the output of the second operational amplifier, and the drain of the fifth transistor is coupled to the drain of the second transistor. The first resistance unit is coupled to the source of the fifth transistor. The second resistance unit is coupled to the drain of the fourth transistor.

In one or more embodiments, the first resistance unit includes a positive temperature coefficient (PTC) thermistor and a negative temperature coefficient (NTC) thermistor. The NTC thermistor is coupled in series with the PTC thermistor.

In one or more embodiments, the input voltage adjusting unit includes a third resistance unit and a fourth resistance unit. The third resistance unit is coupled between an input of the input voltage adjusting unit for receiving the input voltage signal and a point for outputting the adjusted input voltage signal. The fourth resistance unit is coupled between the point and a grounding end.

In one or more embodiments, the third resistance unit includes a laser trimmable resistor or a digitally controlled resistor.

In one or more embodiments, the fourth resistance unit includes a laser trimmable resistor or a digitally controlled resistor.

In one or more embodiments, the photographic module further includes an input voltage generating unit for providing the input voltage signal.

In one or more embodiments, the motor is a voice coil motor.

Another aspect of the invention is to provide a photographic module. The photographic module includes a lens unit, an image sensor unit, an image signal processing unit, a motor and a driving circuit. The image sensor unit is configured to receive incident light of an object scene through the lens unit and convert the incident light into an image signal. The image signal processing unit is coupled to the image sensor unit. The image signal processing unit is configured to process the image signal to obtain a focus adjustment indication signal. The motor is coupled to the lens unit. The motor is configured to adjust a position of the lens unit relative to the image sensor unit based on a sink current. The driving circuit is coupled to the motor and the image signal processing unit. The driving circuit includes an input voltage adjusting unit, a digital-to-analog converting unit, a current mirror unit and a sink current generating unit. The input voltage adjusting unit is configured to convert an input voltage signal into an adjusted input voltage signal. The digital-to-analog converting unit is coupled to the input voltage adjusting unit, which is configured to convert the adjusted input voltage signal and the focus adjustment indication signal into a fraction of the adjusted input voltage signal. The current mirror unit is coupled to the digital-to-analog converting unit, which is configured to amplify the fraction of the adjusted input voltage signal. The sink current generating unit is coupled to the current mirror unit and the motor, which is configured to generate the sink current.

In one or more embodiments, the motor is a voice coil motor.

In one or more embodiments, the image sensor unit is a complementary metal-oxide semiconductor (CMOS) sensor or a charge coupled device (CCD).

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a schematic diagram of a photographic module in accordance with some embodiments of the invention;

FIG. 2 is a schematic diagram of the driving circuit shown in FIG. 1;

FIG. 3 is a circuit diagram of the input voltage adjusting unit shown in FIG. 2;

FIG. 4 is a circuit diagram of the current mirror unit shown in FIG. 2; and

FIG. 5 is a circuit diagram of the sink current generating unit shown in FIG. 2.

### DETAILED DESCRIPTION

Reference will now be made in detail to the embodiments of the invention, examples of which are illustrated in the accompanying drawings. Wherever possible, the same reference numbers are used in the drawings and the description to refer to the same or like parts.

The term “coupled” along with their derivatives may be used herein to indicate that two or more elements are in direct physical or electrical contact with each other, or may also mean that two or more elements may not be in direct contact with each other. The term “coupled” may still be used to indicate that two or more elements cooperate or interact with each other.

It will be understood that, although the terms “first,” “second,” “third,” “fourth” and “fifth” may be used herein to describe various elements and/or components, these elements and/or components should not be limited by these terms. These terms are only used to distinguish one element or component from another.

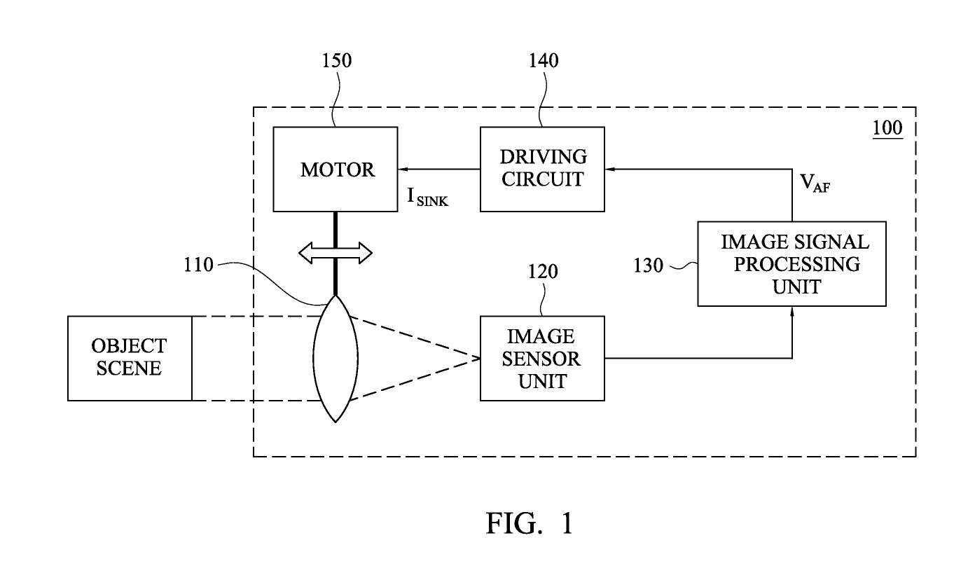

Referring to FIG. 1, which is a schematic diagram of a photographic module 100 in accordance with some embodiments of the invention. In FIG. 1, the photographic module 100 includes a lens unit 110, an image sensor unit 120, an image signal processing unit 130, a driving circuit 140 and a motor 150. The image sensor unit 120 receives an object scene through the lens unit 110 and then converts incident light of the object scene into an image signal. In some embodiments, the image sensor unit 120 is a complementary metal-oxide semiconductor (CMOS) sensor or a charge coupled device (CCD). The image signal processing unit 130 is configured to perform processes on the image signal, such as filtering, smoothing, sharpening, color compensation, and/or the like. When the photographic module 100 is operated in auto-focusing (AF) mode, the image signal processing unit 130 calculates a focus value based on the image signal, and then obtains a focus adjustment indication signal V_{AF} corresponding to the focus value. The driving circuit 140 generates a sink current I_{SINK} based on the focus adjustment indication signal V_{AF}, and drives the motor 150 to adjust a position of the lens unit 110 in the photographic module based on the sink current I_{SINK}. In some embodiments, the motor 150 is a voice coil motor.

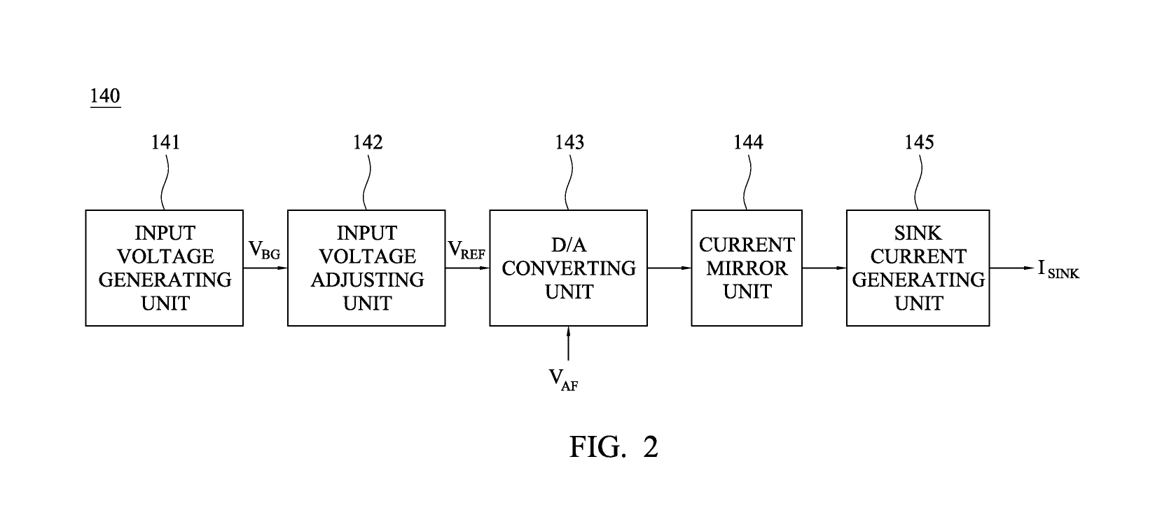

FIG. 2 is a schematic diagram of the driving circuit 140 shown in FIG. 1. In FIG. 2, the driving circuit 140 includes an input voltage generating unit 141, an input voltage adjusting unit 142, a digital-to-analog converting unit 143, a current mirror unit 144 and a sink current generating unit 145. The input voltage generating unit 141 is configured to generate an input voltage signal V_{BG}. In some embodiments, the input voltage generating unit 141 is a bandgap voltage reference for generating the input voltage signal V_{BG} that is irrelevant to power supply variations and temperature changes.

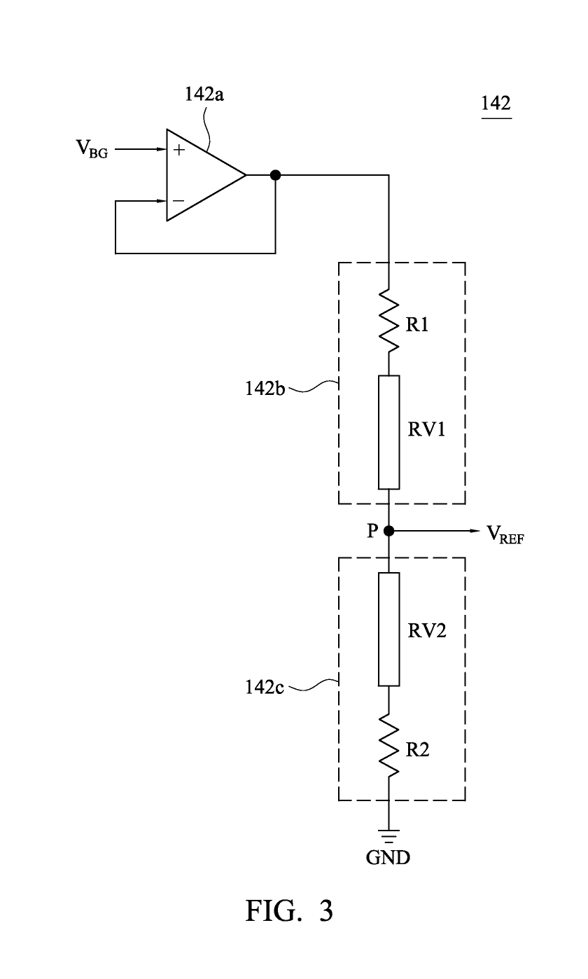

The input voltage adjusting unit 142 is configured to convert the input voltage signal V_{BG} into an adjusted input voltage signal V_{REF}. Some embodiments of the input voltage adjusting unit 142 are shown in FIG. 3. In FIG. 3, the input voltage adjusting unit 142 includes an operational amplifier 142a, and resistance units 142b and 142c. In the operational amplifier 142a, the positive input is configured to receive the input voltage signal V_{BG}, and the negative input is coupled to the output. The resistance unit 142b includes a resistor R1 and a variable resistor RV1 coupled in series, and the resistance unit 142c includes a resistor R2 and a variable resistor RV2 coupled in series. The resistor R1 is coupled to the output of the operational amplifier 142a, and the resistor R2 is coupled to a grounding end GND. The variable resistors RV1 and RV2 are coupled to a point P for outputting the adjusted input voltage signal V_{REF}. The variable resistor RV1 or RV2 may be a laser trimmable resistor, a digitally controlled variable resistor, or the like. In some embodiments, the resistance units 142b and 142c only include the variable resistors RV1 and RV2, respectively.

The digital-to-analog converting unit 143 is coupled to the input voltage adjusting unit 142 for converting the adjusted input voltage signal V_{REF} and the focus adjustment indication signal V_{AF} into a fraction of the adjusted input signal V_{REF}. The focus adjustment indication signal V_{AF} may be an N-bit digital signal. In such case, the fraction to the adjusted input voltage signal V_{REF} is CODE/2^{N}, where CODE represents the decimal value of the focus adjustment indication signal V_{AF}.

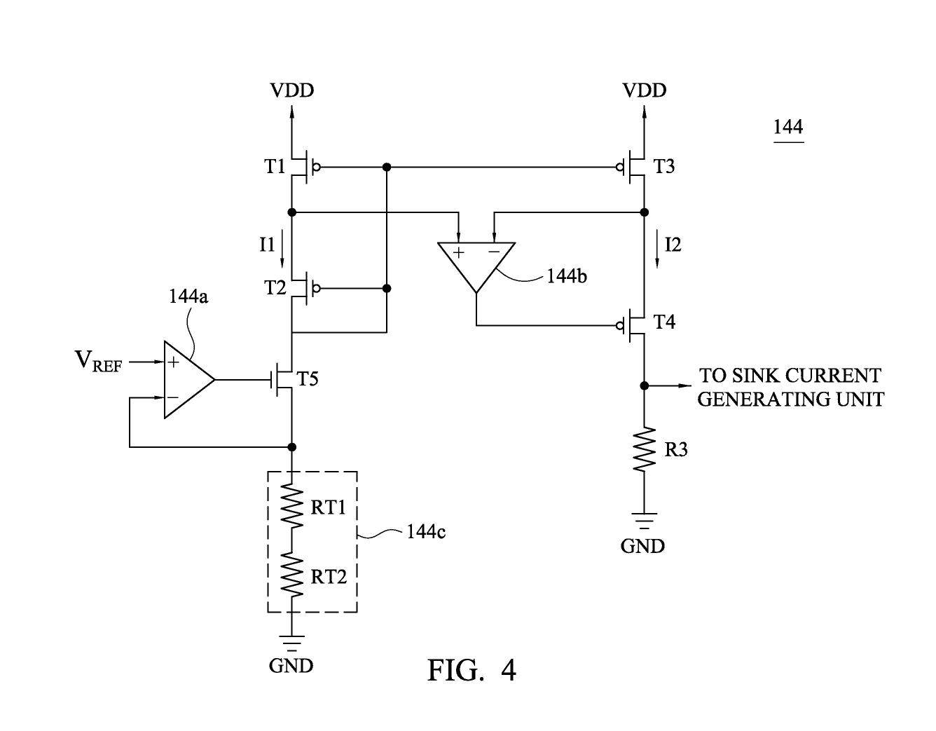

The current mirror unit 144 is coupled to the digital-to-analog converting unit 143. The current mirror unit 144 is configured to amplify the fraction of the adjusted input signal V_{REF}. Some embodiments of the current mirror unit 144 are shown in FIG. 4. In FIG. 4, the current mirror unit 144 includes operational amplifiers 144a and 144b, transistors T1-T5, a resistance unit 144c and a resistor R3. The transistors T1-T4 are P-type metal oxide semiconductor (PMOS) transistors, while the transistor T5 is an N-type metal oxide semiconductor (NMOS) transistor. In the operational amplifier 144a, the positive input is configured to receive the fraction of the adjusted input voltage signal V_{REF}, the negative input is coupled to the source of the transistor T5, and the output is coupled to the gate of the transistor T5. The source of the transistor T1 is coupled to a power supplying end VDD. The source of the transistor T2 is coupled to the drain of the transistor T1, and the drain and gate of the transistor T2 are coupled to the gate of the transistor T1. The source of the transistor T3 is coupled to the power supplying end VDD, and the gate of the transistor T3 is coupled to the gate of the transistor T1. The source of the transistor T4 is coupled to the drain of the transistor T3. In the operational amplifier 144b, the positive input is coupled to the drain of the transistor T1, the negative input is coupled to the drain of the transistor T3, and the output is coupled to the gate of the transistor T4.

The resistance unit 144c is coupled to between the source of the transistor T5 and the grounding end GND, which includes thermistors RT1 and RT2. The thermistors RT1 and RT2 are a positive temperature coefficient (PTC) thermistor and a negative temperature coefficient (NTC) thermistor respectively, or alternatively, the thermistors RT1 and RT2 are a NTC thermistor and a PTC thermistor respectively. The resistor R3 is coupled between the drain of the transistor T4 and the grounding end GND.

In the current mirror unit 144, the gain factor of the transistor T3 is M times the gain factor of the transistor T1, and the operational amplifier 144b can lock the voltage at the drain of the transistor T3 to the voltage at the drain of the transistor T1, such that the current I2 can be fixed to be M times the current I1 regardless of channel length modulation in the transistors T1 and T3.

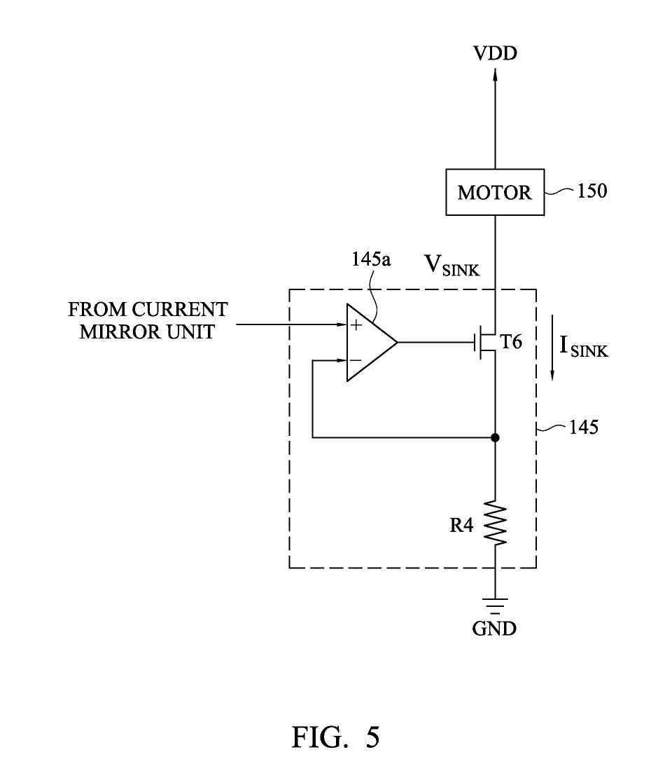

The sink current generating unit 145 is coupled to the current mirror unit 144 and the motor 150. The sink current generating unit 145 for generating the sink current I_{SINK}. Some embodiments of the sink current generating unit 145 are shown in FIG. 5. In FIG. 5, the sink current generating unit 145 includes an operational amplifier 145a, a transistor T6 and a resistor R4. The transistor T6 is a NMOS transistor. In the operational amplifier 145a, the positive input is coupled to the current mirror circuit 144, the negative is coupled to the source of the transistor T6, and the output is coupled to the gate of the transistor T6. The drain of the transistor T6 is coupled to the motor 150. The resistor R4 is coupled between the source of the transistor T6 and the grounding end GND.

According to the embodiments of the invention described above, the sink current I_{SINK} is V_{BG}×K×(CODE/2^{N})×[M/(RT1+RT2)]×(R3/R4), where K is the adjusting factor of the input voltage adjusting unit 142, and V_{BG}×K=V_{REF} . The resistance of the resistor R4 is usually smaller than 1 Ω for providing the sink current I_{SINK} even if the voltage V_{SINK} is small. The sink current I_{SINK} is in proportional to the ratio of the resistance value of the resistor R3 to the resistance value of the resistor R4. In the invention, the resistance unit 144c includes a PTC thermistor and a NTC thermistor (the thermistors R3 and R4), such that the overall resistance value of the resistance unit 144c (i.e. RT1+RT2) remains the same, such that the sink current I_{SINK} does not change with the change of the temperature.

Since the variation of the resistance unit 144c may affect the sink current I_{SINK}, the input voltage adjusting unit 142 adopts variable resistors RV1 and RV2 for adjusting the adjusting factor K of the input voltage adjusting unit 142, such that the variation of the resistance unit 144c can be compensated.

Moreover, the current mirror unit 144 can provide the current I2 with high linearity, the sink current I_{SINK} can be generated with high linearity accordingly, so as to accurately adjust the location of the lens unit 110.

It should be noted that, the types of the transistors illustrated in the drawings are not intended to limit the scope of the invention. For example, the transistors T1-T4 of the current mirror unit 144 can be alternatively implemented by using NMOS transistors with appropriate modification of the circuit in the current mirror unit 144, which is well known to those skilled in the art.

Summing the above, the driving circuit of the invention can provide a sink current with high accuracy to adjust a position of a lens of a photographic module. By using the driving circuit of the invention, the position of the lens of the photographic module can be precisely adjusted, so as to improve the image quality of the photographic module.

Although the invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims.

what is claimed is:

1. A driving circuit for controlling a photographic module, the photographic module having a lens unit and a motor for adjusting a position of the lens unit in the photographic module based on a sink current, the driving circuit comprising:
an input voltage adjusting unit for converting an input voltage signal into an adjusted input voltage signal;
a digital-to-analog converting unit coupled to the input voltage adjusting unit for converting the adjusted input voltage signal and a digitalized signal into a fraction of the adjusted input voltage signal;
a current mirror unit coupled to the digital-to-analog converting unit for amplifying the fraction of the adjusted input voltage signal; and
a sink current generating unit coupled to the current mirror unit and the motor for generating the sink current based on the fraction of the adjusted input voltage signal.

2. The driving circuit of claim 1, wherein the current mirror unit comprises:
a first transistor having a gate and a drain;
a second transistor having a source, a gate and a drain, wherein the source of the second transistor is coupled to the drain of the first transistor, and the gate and the drain of the second transistor is coupled to the gate of the first transistor;
a third transistor having a gate and a drain, wherein the gate of the third transistor is coupled to the gate of the first transistor;
a fourth transistor having a source, a gate and a drain, wherein the source of the fourth transistor is coupled to the drain of the third transistor; and
a first operational amplifier having a positive input, a negative input and an output, wherein the positive input of the first operational amplifier is coupled to the drain of the first transistor, the negative input of the first operational amplifier is coupled to the drain of the third transistor, and the output of the first operational amplifier is coupled to the gate of the fourth transistor.

3. The driving circuit of claim 2, wherein the current mirror unit further comprises:
a second operational amplifier having a positive input, a negative input and an output, wherein the positive input of the second operational amplifier is coupled to the digital-to-analog converting unit;
a fifth transistor having a source, a gate and a drain, wherein the source of the fifth transistor is coupled to the negative input of the second operational amplifier, the gate of the fifth transistor is coupled to the output of the second operational amplifier, and the drain of the fifth transistor is coupled to the drain of the second transistor;
a first resistance unit coupled to the source of the fifth transistor; and
a second resistance unit coupled to the drain of the fourth transistor.

4. The driving circuit of claim 3, wherein the first resistance unit comprises:
a positive temperature coefficient (PTC) thermistor; and
a negative temperature coefficient (NTC) thermistor coupled in series with the PTC thermistor.

5. The driving circuit of claim 1, wherein the input voltage adjusting unit comprises:
a third resistance unit coupled between an input of the input voltage adjusting unit for receiving the input voltage signal and a point for outputting the adjusted input voltage signal; and
a fourth resistance unit coupled between the point and a grounding end.

6. The driving circuit of claim 5, wherein the third resistance unit comprises a laser trimmable resistor or a digitally controlled resistor.

7. The driving circuit of claim 5, wherein the fourth resistance unit comprises a laser trimmable resistor or a digitally controlled resistor.

8. The driving circuit of claim 1, further comprising an input voltage generating unit for providing the input voltage signal.

9. A photographic module, comprising:
a lens unit;
a motor coupled to the lens unit for adjusting a position of the lens unit in the photographic module based on a sink current; and
a driving circuit coupled to the motor, the driving circuit comprising:
an input voltage adjusting unit for converting an input voltage signal into an adjusted input voltage signal;
a digital-to-analog converting unit coupled to the input voltage adjusting unit for converting the adjusted input voltage signal and a digitalized signal into a fraction of the adjusted input voltage signal;
a current mirror unit coupled to the digital-to-analog converting unit for amplifying the fraction of the adjusted input voltage signal; and
a sink current generating unit coupled to the current mirror unit and the motor for generating the sink current based on the fraction of the adjusted input voltage signal.

10. The photographic module of claim 9, wherein the current mirror unit comprises:
a first transistor having a gate and a drain;
a second transistor having a source, a gate and a drain, wherein the source of the second transistor is coupled to the drain of the first transistor, and the gate and the drain of the second transistor is coupled to the gate of the first transistor;
a third transistor having a gate and a drain, wherein the gate of the third transistor is coupled to the gate of the first transistor;
a fourth transistor having a source, a gate and a drain, wherein the source of the fourth transistor is coupled to the drain of the third transistor; and
a first operational amplifier having a positive input, a negative input and an output, wherein the positive input of the first operational amplifier is coupled to the drain of the first transistor, the negative input of the first operational amplifier is coupled to the drain of the third transistor, and the output of the first operational amplifier is coupled to the gate of the fourth transistor.

11. The photographic module of claim 10, wherein the current mirror unit further comprises:
a second operational amplifier having a positive input, a negative input and an output, wherein the positive input of the second operational amplifier is coupled to the digital-to-analog converting unit;
a fifth transistor having a source, a gate and a drain, wherein the source of the fifth transistor is coupled to the negative input of the second operational amplifier, the gate of the fifth transistor is coupled to the output of the second operational amplifier, and the drain of the fifth transistor is coupled to the drain of the second transistor;
a first resistance unit coupled to the source of the fifth transistor; and
a second resistance unit coupled to the drain of the fourth transistor.

12. The photographic module of claim 11, wherein the first resistance unit comprises:
a positive temperature coefficient (PTC) thermistor; and
a negative temperature coefficient (NTC) thermistor coupled in series with the PTC thermistor.

13. The photographic module of claim 9, wherein the input voltage adjusting unit comprises:
a third resistance unit coupled between an input of the input voltage adjusting unit for receiving the input voltage signal and a point for outputting the adjusted input voltage signal; and
a fourth resistance unit coupled between the point and a grounding end.

14. The photographic module of claim 13, wherein the third resistance unit comprises a laser trimmable resistor or a digitally controlled resistor.

15. The photographic module of claim 13, wherein the fourth resistance unit comprises a laser trimmable resistor or a digitally controlled resistor.

16. The photographic module of claim 9, further comprising an input voltage generating unit for providing the input voltage signal.

17. The photographic module of claim 9, wherein the motor is a voice coil motor.

18. A photographic module, comprising:
a lens unit;
an image sensor unit for receiving incident light of an object scene through the lens unit and converting the incident light into an image signal;
an image signal processing unit coupled to the image sensor unit for processing the image signal to obtain a focus adjustment indication signal;
a motor coupled to the lens unit for adjusting a position of the lens unit relative to the image sensor unit based on a sink current; and
a driving circuit coupled to the motor and the image signal processing unit, the driving circuit comprising:
an input voltage adjusting unit for converting an input voltage signal into an adjusted input voltage signal;
a digital-to-analog converting unit coupled to the input voltage adjusting unit for converting the adjusted input voltage signal and the focus adjustment indication signal into a fraction of the adjusted input voltage signal;
a current mirror unit coupled to the digital-to-analog converting unit for amplifying the fraction of the adjusted input voltage signal; and
a sink current generating unit coupled to the current mirror unit and the motor for generating the sink current.

19. The photographic module of claim 18, wherein the motor is a voice coil motor.

20. The photographic module of claim 18, wherein the image sensor unit is a complementary metal-oxide semiconductor (CMOS) sensor or a charge coupled device (CCD).
